(19) United States
(12) Patent Application Publication
(10) Pub. No.: US 2017/0282187 A1
(43) Pub. Date: Oct. 5, 2017

(54) Pipette Tips with Vertical Ribs

(71) Applicant: FELIX H. YIU, COVINA, CA (US)

(72) Inventor: FELIX H. YIU, COVINA, CA (US)

(21) Appl. No.: 14/452,445

(22) Filed: Aug. 5, 2014

(51) Int. Cl. B01L 9/00; B01L 3/02

(52) U.S. Cl. CPC B01L 9/543; B01L 3/0275; B01L 9/50; B01L 2300/0809; B01L 2300/12

(57) ABSTRACT

An apparatus for assembling together a plurality of pipette tips into a single line or a rectangular array using a tip collar that will provide structural rigidity to the plurality of pipette tips. The tips are manufactured with vertical ribs and the tip collar is manufactured to achieve a friction fit with the vertical ribs of the tips, thereby producing a tip and collar assembly that is easier to manufacture, lower in cost, and more convenient for the operator.

### CROSS-REFERENCE TO RELATED APPLICATIONS

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

The present invention is used in the field of small volume liquid pipetting using the air displacement pipetting technique. These air displacement pipettors are used to pipette or aspirate and dispense (transfer) small volumes of liquid, a typical volume range being 1 microliter to 1 milliliter of liquid. A common method for containing the liquid is to use a disposable pipette tip to hold the liquid after it is aspirated and before it is dispensed. The most common material to produce the pipette tips is polypropylene. The advantage of a disposable pipette tip in comparison to a reusable fixed tip is that the liquid being pipetted only comes into contact with the disposable tip, which is discarded after each use thus preventing any carryover or sample-to sample contamination in between pipetting operations. The reusable fixed tips must be washed in between each pipetting operation, and even the washing protocol does not guarantee complete elimination of carryover. Because of this the use of disposable pipette tips is very common for this application.

Air displacement pipettors can be constructed to pipette one liquid sample at a time, or more than one. When more than one sample is pipetted at the same time, this is commonly referred to as a multichannel pipettor. Commonly available multichannel air displacement pipettors may use a number of disposable tips arranged in a single row, or a number of pipette tips arranged in a grid fashion (array pattern). It is a standard in the industry to pipette to and from microtiter plates that have an industry-accepted spacing of liquid containers, or wells. These microtiter plates, also called microplates, commonly have 96 wells arranged in an 8×12 grid or 384 wells arranged in a 16×24 grid. The spacing between wells is defined by the industry-accepted standard. This allows multichannel air displacement pipettors to be constructed that are able to access multiple wells all at once for pipetting, either in a single row or as a grid.

In the current art it is common to package pipette tips either loose-packed or in racks. When packaged as loose-packs, a large number of individual pipette tips are placed into a bag. This is the most economical way of packaging disposable pipette tips, but it requires extra work for the operator because the tips must be individually removed from the bag and placed into some sort of holder or rack in order to be loaded onto the pipettor. Because of this, the more common method is to supply the tips in racks, which provide more convenience and ease of use for the operator since they are ready to be loaded into the pipettor. Because of the industry standard of pipetting into microplates, the commonly available racks of tips are in the 8×12 format for 96 total tips or 16×24 format for 384 total tips. These provide a convenient system for loading tips onto the pipettor in batches of 96 or 384.

The present invention is a novel design that addresses the shortcomings of the current art for the manufacturing, packaging, and usage of disposable pipette tips. The pipette tips feature a vertical rib design and sealing flange that allow the tips to be more easily and reliably loaded into the collar. The dimensions of the collar holes for accepting the tips are designed in conjunction with the dimensions of the vertical ribs such that a friction fit is achieved when the tips are placed into the collar.

The prior art method of using a disposable collar to hold a collection of pipette tips is functional. However, because of the loose fit of the pipette tips in the collar, it has a number of limitations that make this method less than ideal.

One limitation is that it is possible for some or all of the tips to become misaligned. In order to produce the best pipetting results for precision and accuracy, it is critical that the alignment of the tips be perfectly in the vertical direction and not varying from side to side or front to back. In addition, if the tips are misaligned and not perfectly straight, there is an increase possibility that tip breakage can occur due to undesired contact between the tips and other surfaces.

Another limitation is that the pipette tips are not locked into the disposable collar which results in the possibility of some or all of the tips falling out of the collar if the user orients the collar from the horizontal position. This requires the user to then manually reload all of the fallen tips into the collar and also creates the opportunity for contamination of the tips which can negatively impact the experimental results or even require that set of tips to be discarded before even being used.

The present invention is a novel design that addresses the shortcomings of the current art for packaging a plurality of pipette tips into a collar. The design of the tips and collar is such that a either a single line of tips or an array of tips can be loaded onto either a manually-operated handheld pipettor or an automated motor-driven operator with an easy operation requiring less force than the current art.

### BRIEF SUMMARY OF THE INVENTION

The present invention is a novel design that addresses the shortcomings of the current art for the manufacturing, packaging, and usage of disposable pipette tips. The pipette tips feature a vertical rib design and sealing flange that allow the tips to be more easily and reliably loaded into the collar. The dimensions of the collar holes for accepting the tips are designed in conjunction with the dimensions the vertical ribs such that a friction fit is achieved when the tips are placed into the collar. This design allows the tip and collar assembly to be manufactured in a more reliable and lower-cost manner. The invention also provides a convenient method for reliably and reproducibly aligning all of the pipette tips, either configured in a single line or a rectangular array, which is critical to maintain pipetting performance. In addition, the invention allows the production of a collar with tips loaded from the top that will maintain integrity during handling by the operator, even if the assembly is completely inverted. This design addresses one of the most common complaints concerning this style of tip and collar assembly, where the tips are loose-fit into the collar and will fall out if the assembly is tipped.

It is an objective of the invention to create a unitary entity between a single line or rectangular array of multiple pipette tips and a tip collar that provides structural rigidity to allow for ease of installation between the assembly set of pipette tips and a pipetting head adaptor.

It is another objective of the invention to create an assembly set of a single line or rectangular array of pipette tips that is easily adaptable to fit onto an automated pipettor machine.

It is yet another objective of the present invention to provide an assembly set of pipette tips that can be easily disposable.

It is yet another objective of the present invention to create an apparatus for assembling multiple pipette tips that is inexpensive to manufacture.

It is yet another objective of the present invention to allow easier handling of the tip and collar assembly by preventing the tips from moving or falling out even if the tip and collar assembly is completely inverted.

It is yet another objective of the present invention to create a seal at the top surface of the pipette tips when connected to a pipettor using a gasket mating instead of through interference within the internal walls of the open proximal end of the pipette tips.

It is yet another objective of the present invention to allow a pipettor to connect to a plurality of pipette tips without breaking the pipette tips.

These and other advantages and features of the present invention are described with specificity so as to make the present invention understandable tone of ordinary skill in the art.

### DESCRIPTION OF SEVERAL VIEWS OF THE DRAWINGS

FIG. 1 is a perspective view and expanded view of one embodiment of the invention which is a single pipette tip with vertical ribs and top-located sealing flange.

FIG. 2 is a perspective view of the same embodiment of the current invention as shown in FIG. 1 where a single line of tips is shown before and after having been loaded into tip collar.

FIG. 3 is a perspective view of the same embodiment of the current invention as shown in FIG. 1 where an array of tips is shown before and after having been loaded into tip collar.

FIG. 4. is a side elevation and cutaway close-up of the same embodiment of the current invention as shown in FIG. 2.

FIG. 5 is a perspective view and expanded view of a second embodiment of the invention which is a single pipette tip with vertical ribs and mid-located sealing flange.

FIG. 6 is a perspective view of the same embodiment of the current invention as shown in FIG. 5 where a single line of tips is shown before and after having been loaded into tip collar.

FIG. 7 is a perspective view of the same embodiment of the current invention as shown in FIG. 5 where an array of tips is shown before and after having been loaded into tip collar.

FIG. 8. is a side elevation and cutaway close-up of the same embodiment of the current invention as shown in FIG. 5.

### DETAILED DESCRIPTION OF THE INVENTION

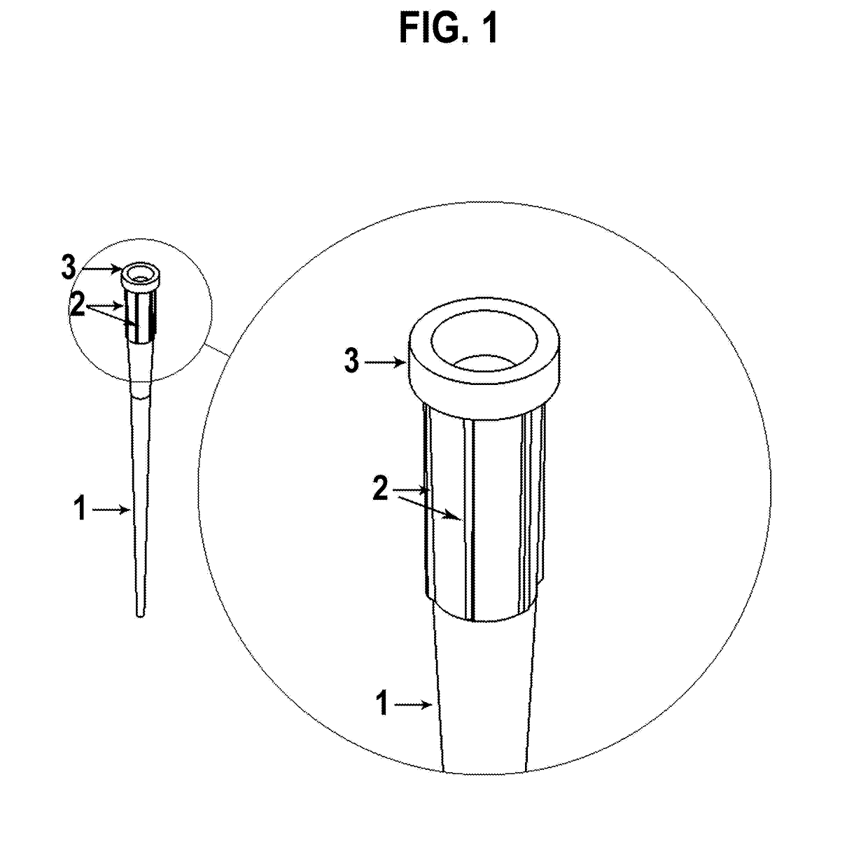

FIG. 1 gives a perspective view and close-up view of one embodiment of the current invention. The pipette tip 1 has a series of vertical ribs 2 molded into its upper part. In this embodiment of the current invention the sealing flange 3 is molded into the very top of the pipette tip 1.

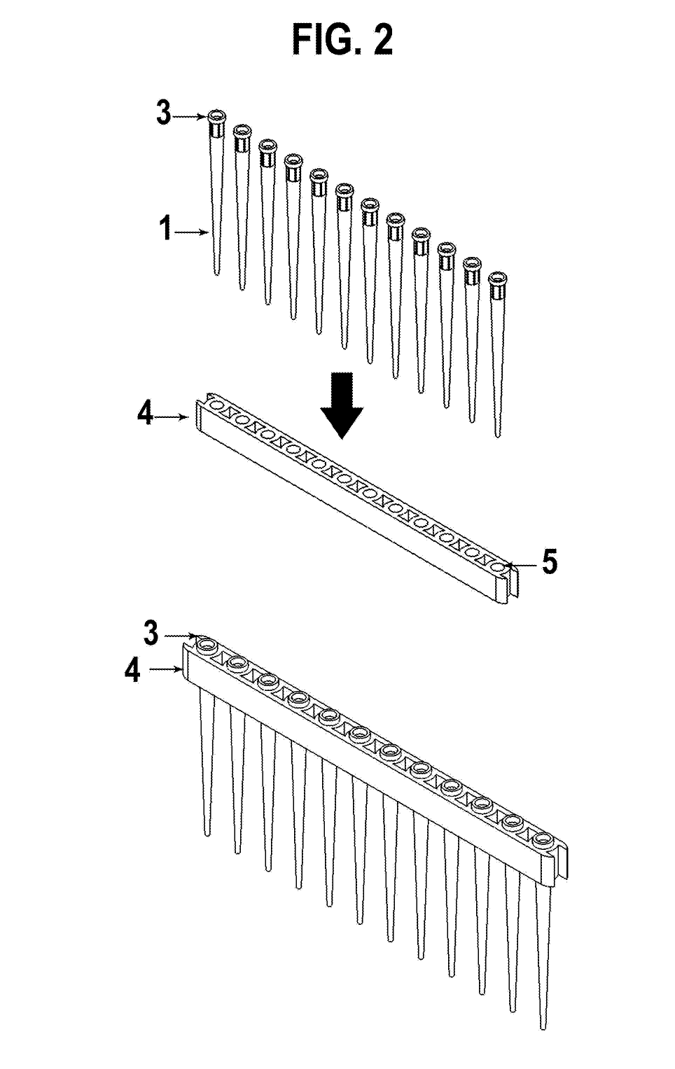

FIG. 2 shows a perspective view of the same embodiment of the current invention as shown in FIG. 1. The tips 1 are shown before and after having been loaded into the collar 4. In the first embodiment of the current invention the tips 1 are loaded into the collar 4 from the top. In this version of the first embodiment the tips 1 are organized into a single line. The collar 4 is manufactured with a series of holes 5 that accept the tips 1. During the packaging process the tips 1 are placed downward into the holes 5 of collar 4. The flange 3 will be positioned directly against the top of the collar 4 thus locking all of the tips 1 into position in a consistent pattern. The top edge of the flange 3 is therefore positioned in a consistent and reliable pattern to provide optimal sealing of the tip to a sealing mat when it is loaded into the pipettor.

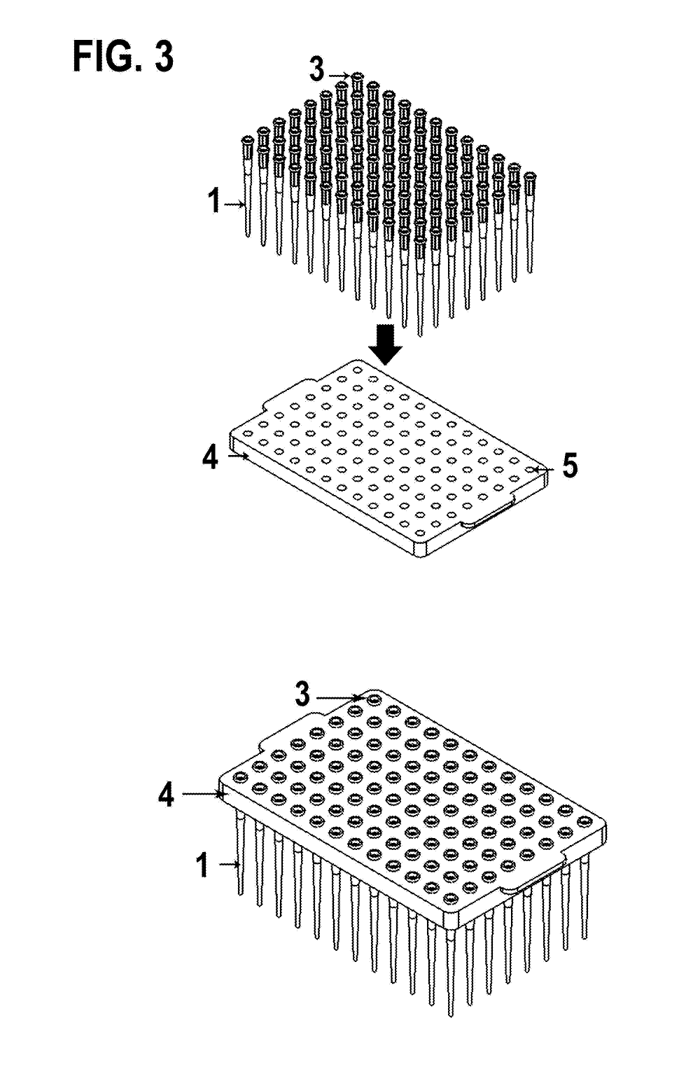

FIG. 3 shows a perspective view of the same embodiment of the current invention as shown in FIG. 1. The tips 1 are shown before and after having been loaded into the collar 4. In the first embodiment of the current invention the tips 1 are loaded into the collar 4 from the top. In this version of the first embodiment the tips 1 are organized into a rectangular array. The collar 4 is manufactured with a series of holes 5 that accept the tips 1. During the packaging process the tips 1 are placed downward into the holes 5 of the collar 4. The flange 3 will be positioned directly against the top of the collar 4 thus locking all of the tips 1 into position in a consistent pattern. The top edge of the flange 3 is therefore positioned in a consistent and reliable pattern to provide optimal sealing of the tip to a sealing mat when it is loaded into the pipettor.

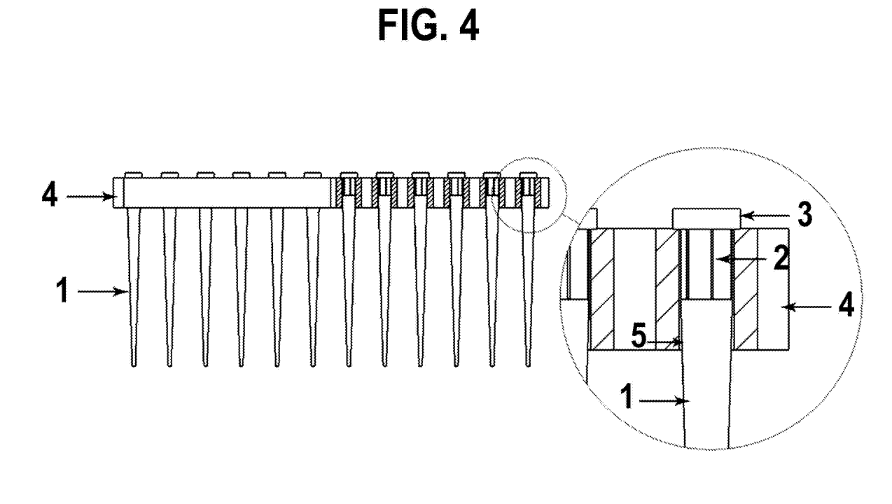

FIG.4 shows a cutaway side view and close-up of the same embodiment of the current invention as shown in FIG. 2. This embodiment of the invention is intended to apply to any pattern of tips that are loaded in to the tip collar, either as a single line of tips or a rectangular array of tips. The cutaway view shows the tips 1 installed into the collar 4 by inserting them from the top. The bottom edge of the flange 3 is positioned against the top edge of the collar 4. This provides the proper positioning and alignment of the flanges 3 at the top of the collar 4 to provide the proper seal when loaded into the pipettor. The vertical flanges 2 of the tips 1 are pressed against the interior surface of the holes 5 by friction. The manufacturing tolerances of the vertical ribs 2 and the hole 5 diameters allow a consistent fit that will hold the tips 1 in position within the collar 4 even if the assembly is inverted.

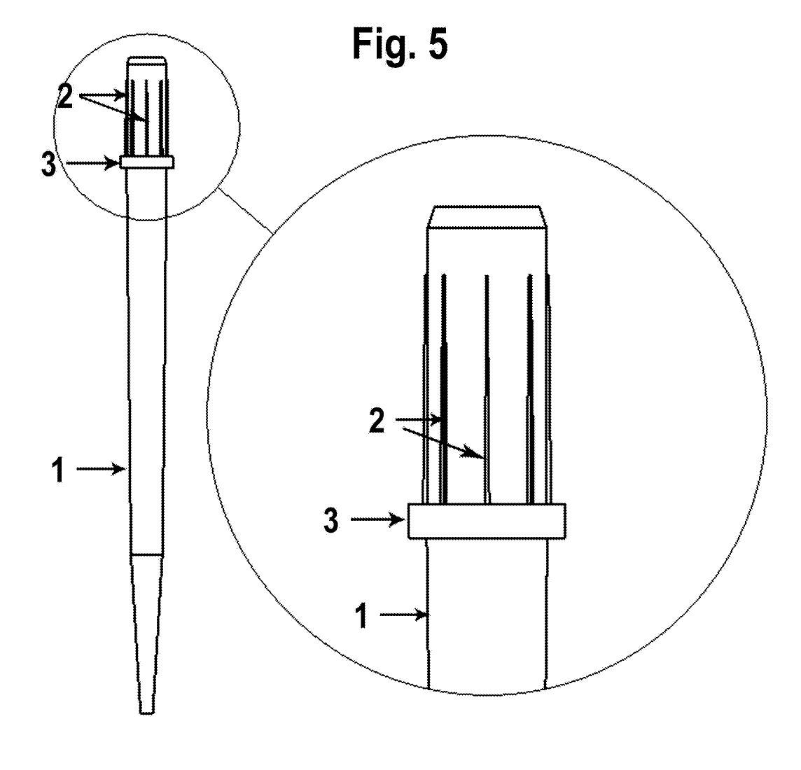

FIG. 5 gives a perspective view and close-up view of a second embodiment of the current invention. The pipette tip 1 has a series of vertical ribs 2 molded into its upper part. In this embodiment of the current invention the sealing flange 3 is a short downward distance from the very top of the pipette tip 1.

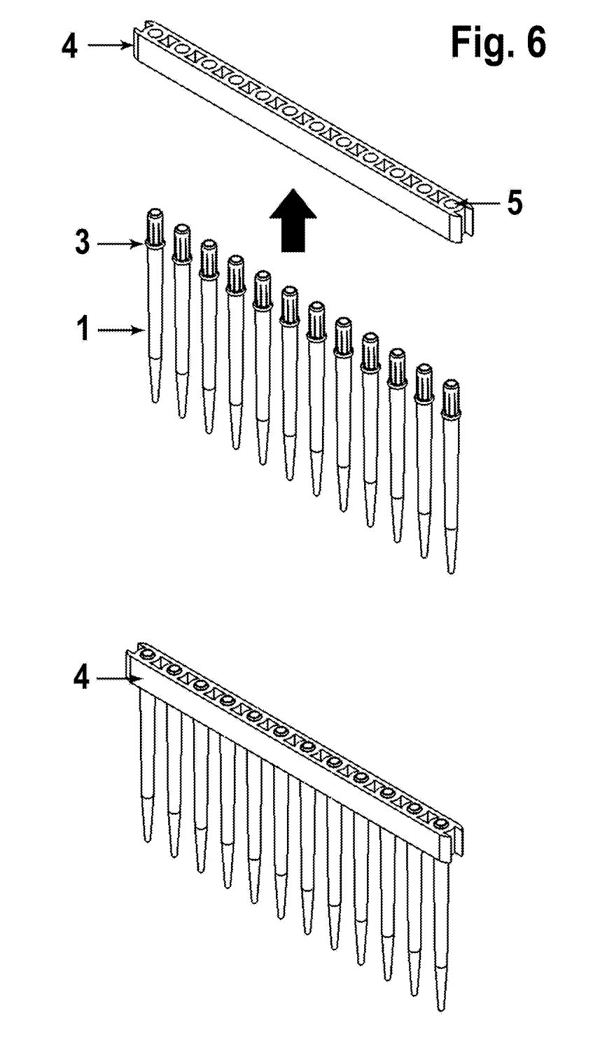

FIG. 6 shows a perspective view of the second embodiment of the current invention as shown in FIG. 5. The tips 1 are shown before and after having been loaded into the collar 4. In this second embodiment of the current invention the tips 1 are loaded into the collar 4 from the bottom. In this version of the second embodiment the tips 1 are organized into a single line. The collar 4 is manufactured with a series of holes 5 that accept the tips 1. During the packaging process the tips 1 are placed upward into the holes 5 of collar 4. The flange 3 will be positioned directly against the bottom of the collar 4 thus locking all of the tips 1 into position in a consistent pattern. The top edges of the tips 1 are therefore positioned slightly protruding above hole 5 in a consistent and reliable pattern to provide optimal sealing of the tip to a sealing mat when it is loaded into the pipettor.

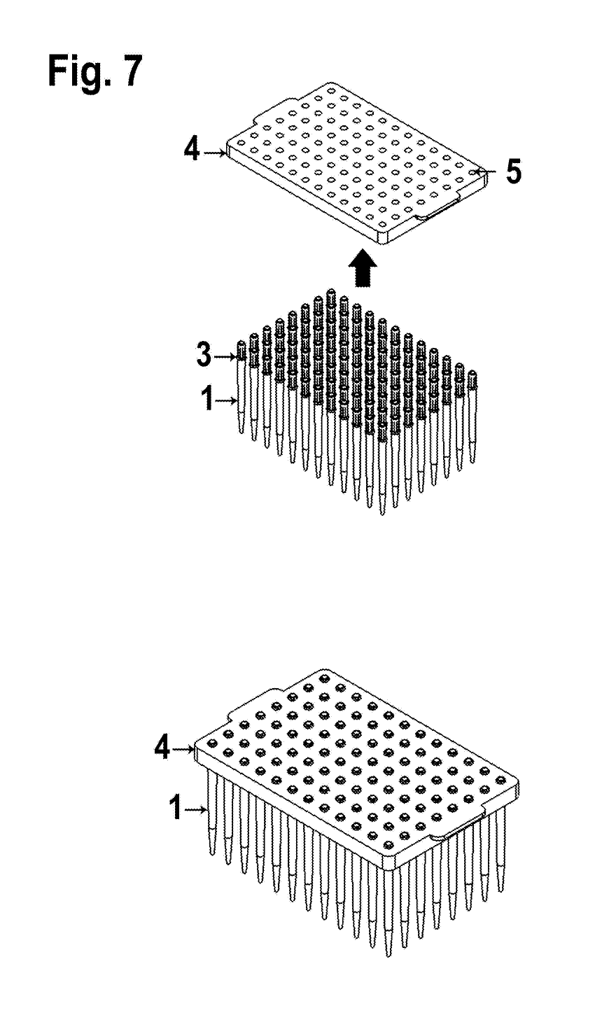

FIG. 7 shows a perspective view of the second embodiment of the current invention as shown in FIG. 5. The tips 1 are shown before and after having been loaded into the collar 4. In this second embodiment of the current invention the tips 1 are loaded into the collar 4 from the bottom. In this version of the second embodiment the tips 1 are organized into a rectangular array. The collar 4 is manufactured with a series of holes 5 that accept the tips 1. During the packaging process the tips 1 are placed upward into the holes 5 of the collar 4. The flange 3 will be positioned directly against the bottom of the collar 4 thus locking all of the tips 1 into position in a consistent pattern. The top edges of the tips 1 are therefore positioned in a consistent and reliable pattern to provide optimal sealing of the tip to a sealing mat when it is loaded into the pipettor.

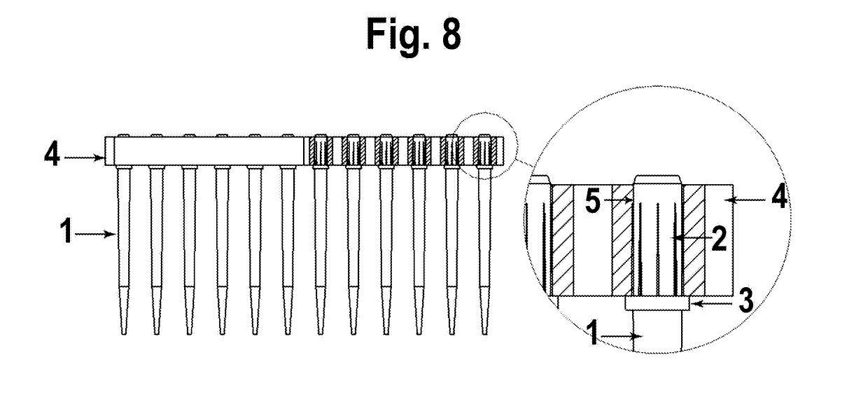

FIG.8 shows a cutaway side view and close-up of the second embodiment of the current invention as shown in FIG. 5. This embodiment of the invention is intended to apply to any pattern of tips that are loaded into the tip collar, either as a single line of tips or a rectangular array of tips. The cutaway view shows the tips 1 installed into the collar 4 by inserting them from the bottom. The top edge of the flange 3 is positioned against the bottom edge of the collar 4. This provides the proper positioning and alignment of the top edges of the tips 1 at the top of the collar 4 to provide the proper seal when loaded into the pipettor. The vertical flanges 2 of the tips 1 are pressed against the interior surface of the holes 5 by friction. The manufacturing tolerances of the vertical ribs 2 and the hole 5 diameters allow a consistent fit that will hold the tips 1 in position within the collar 4 even if the assembly is inverted.

The invention is an entirely new and novel way to manufacture a unitary entity consisting of a collar and pipette tips that addresses the shortcomings of the prior art.

An advantage of the invention compared to the current art is that the pipette tips are held in the collar in a consistently-aligned pattern. By keeping the pipette tips in perfect vertical alignment in this manner, the pipetting results (precision and accuracy) will be better compared to an arrangement where some or all of the tips are not in alignment. In addition, the chance of breakage of the tips is reduced when they are held in perfect alignment.

Another advantage of the invention is that the pipette tips are held firmly in place within the collar. During shipping and handling the tips will not shift or move from their positions in the holes in the collars. A major advantage of this design over the prior art is that id the user inadvertently or intentionally inverts the position of the tip collar from horizontal, the tips will remain in place, unlike prior art designs where the tips will move or fall out of the collar. This is more convenient for the operator and also prevents the chance for contamination of the tips due to manual handling after they have fallen out of the collar.

1. I claim a tip collar for assembling together a plurality of pipette tips in a single line configuration or a rectangular array configuration each having a shoulder flange comprising: a plurality of axially placed holes in a single line or a rectangular array on said tip collar adaptable to receive said plurality of pipette tips in a single line or rectangular array; wherein said tip collar allows said plurality of pipette tips to rigidly rest therein by forming an assembly set of pipette tips,

2. I claim the tip collar and tip assembly are connected by an upward lifting force exerted on a shoulder flange of each of said plurality of pipette tips or by an upward lifting force exerted on the bottom edge of the tip collar.

3. I claim a design of pipette tips molded with vertical ribs.

4. I claim the tip collar holes that accept the pipette tips are of a dimension such that the tips will be held in position by friction after being loaded into the holes. The tips will remain in position even if the tip and collar assembly is inverted.
